(19) United States
(12) Patent Application Publication
(10) Pub. No.: US 2014/0010143 A1
(43) Pub. Date: Jan. 9, 2014

(54) COOPERATIVE RELAY IN MBMS TRANSMISSION

(71) Applicant: Steve Barrett, West Sussex (GB)

(72) Inventor: Steve Barrett, West Sussex (GB)

(73) Assignee: Nvidia Corporation, Santa Clara, CA (US)

(21) Appl. No.: 14/006,881

(22) PCT Filed: Mar. 16, 2012
(86) PCT No.: PCT/EP2012/054661

§ 371 Date: Sep. 23, 2013

(30) Foreign Application Priority Data
Mar. 24, 2011 (GB) 1104981.4

(51) Int. Cl. H04B 7/155

(52) U.S. Cl. CPC H04B 7/15592
USPC 370/312

(57) ABSTRACT

A mobile radio communications network for communicating broadcast data to a plurality of mobile communications devices by transmitting and receiving the broadcast data via a wireless access interface includes one or more base stations for transmitting signals to and receiving signals from mobile communications devices attached to the base stations, and a relay node arranged in operation to receive a first signal representing the broadcast data transmitted by one of the base stations to the relay node via a first down-link channel of the wireless access network, and to retransmit the broadcast data as a second signal for reception by one or more of the mobile communications devices via a second channel of the wireless access network. The first channel between the relay node and the base station includes an up-link channel for transmitting signals from the relay node to the base station and a down-link channel for transmitting signals from the base station to the relay node and the base station is arranged to communicate timing advance information and the relay node is adapted to adjust a timing of the transmission of the second signal via the second channel using the timing information provided by the base station. Accordingly a single frequency network can be formed with relay nodes and base stations in which mobile communications devices can receive signals representing the broadcast data transmitted from the relay nodes and the base stations substantially contemporaneously.

### FIELD OF THE INVENTION

The present invention relates to mobile radio networks which are arranged to communicate data to and from mobile communications devices via a wireless access interface. The present invention also relates to relay nodes for mobile radio networks and methods for communicating data with mobile radio networks.

### BACKGROUND OF THE INVENTION

Mobile communication systems have evolved over the past ten years or so from the GSM System (Global System for Mobiles) to the 3G system and now include packet data communications as well as circuit switched communications. The third generation project partnership (3GPP) has now begun to develop a mobile communication system referred to as Long Term Evolution (LTE) in which a core network part has been evolved to form a more simplified architecture based on a merging of components of earlier mobile radio network architectures and a radio access interface which is based on Orthogonal Frequency Division Multiplexing (OFDM) on the downlink and Single Carrier Frequency Division Multiple Access (SC-FDMA) on the uplink.

Multimedia Broadcast Multicast Service (MBMS) has been developed by the third generation project partnership (3GPP) to provide an arrangement in which data can be transmitted from one or more cells of a mobile radio network to mobile communications devices which have subscribed to that service. For example a television programme or multi media event can be transmitted to a plurality of mobile communications devices by contemporaneously transmitting broadcast data representing the programme or multi media event to the mobile communications devices from some or all of the base stations which form part of the network. An enhanced Multimedia Broadcast Multicast Service (eMBMS) is an arrangement which is provided within the standardisation of the LTE standards within 3GPP. In particular, the eMBMS standard utilises physical layer characteristics of the LTE standard which uses Orthogonal Frequency Division Multiplexing (OFDM) on the down link to transmit the eMBMS data to mobile communication devices. A feature of OFDM is that a Fourier Transform can be used to transform the time domain received OFDM symbol into the frequency domain. This is because the signal is formed in the frequency domain and transformed using an inverse FFT into the time domain for transmission. At the receiver the time domain signal, which may have reached the receiver from multiple paths and indeed multiple sources, is transformed into the frequency domain in order to recover data symbols carried by the OFDM symbol. As such, signals representing the OFDM symbol from a plurality of different sources are combined at the receiver in a constructive way. Thus, a single frequency network can be formed for eMBMS, which can be referred to as MBSFN. Indeed the e-UTRAN system is being developed within LTE to provide for a single frequency network mode of operation in which a single frequency network can be shared with non MBMS services. Other systems which can be used to form a single frequency network include the Integrated Mobile Broadcast (IMB) system which uses Code Division Multiple Access (CDMA) to form a single frequency network. For this example a spread spectrum signal can be received and combined from different sources using a Rake receiver.

It has been proposed within LTE to use so-called relay nodes which can be disposed in a mobile radio network in order to extend the radio coverage of that mobile radio network and in particular in respect of MBMS services. A relay node is an autonomous unit which receives data transmitted by a base station and re-transmits that data to mobile communications devices, which may be within the range of the relay node, but outside the range of the base station, thereby increasing a range of the base station concerned.

As will be appreciated, it is desirable to use communications resources available to a mobile radio network as efficiently as possible when providing wireless communications to mobile communications devices.

### SUMMARY OF THE INVENTION

According to the present invention there is provided a mobile radio communications network for communicating broadcast data to a plurality of mobile communications devices by transmitting and receiving the broadcast data via a wireless access interface includes one or more base stations arranged in operation to transmit signals to and receive signals from mobile communications devices attached to the base stations, and a relay node arranged in operation to receive a first signal representing the broadcast data transmitted by one of the base stations to the relay node via a first down-link channel of the wireless access network, and to retransmit the broadcast data as a second signal for reception by one or more of the mobile communications devices via a second channel of the wireless access network. The first channel between the relay node and the base station includes an up-link channel for transmitting signals from the relay node to the base station and a down-link channel for transmitting signals from the base station to the relay node and the base station is arranged to communicate timing advance information for use by the relay node in transmitting signals in the up-link channel to the base station and the relay node is adapted to adjust a timing of the transmission of the second signal via the second channel using the timing information provided by the base station.

As explained above a mobile radio network operating, for example, in accordance with an LTE standard can be arranged to form a single frequency network.

In one example, in order to provide an arrangement in which relay nodes can be included in the transmission of broadcast data with the transmission of the broadcast data from the base stations, signals representing the broadcast data should transmitted by the relay node, as far as possible, in synchronism with the transmission of the signals representing the broadcast data form the base station. This is so that a receiving mobile communications device can combine the signals received from the base station and the relay node in accordance with a simul-cast arrangement, which for the example of LTE may use the properties of OFDM as explained above.

In order to form a single frequency network the receiver in the mobile communication device should receive the signal from the base station and the signal from the relay node at the same time and for the example of OFDM within a guard period of the cyclic prefix of the OFDM symbols. Therefore, as far as possible, the transmission of the signals from the base station and the relay node should be synchronised. To this end, the embodiments of the present invention arrange for the relay node to utilise timing advance information which is provided by the base station as a part of a conventional operation of a wireless access interface which provides a paired up-link and down-link channel on a bearer assigned for communication, as if the relay node was acting as a mobile communications device itself.

Accordingly a single frequency network can be formed with relay nodes and base stations in which mobile communications devices can receive signals representing the broadcast data transmitted from the relay nodes and the base stations which have been transmitted by the base stations and the relay nodes substantially contemporaneously.

Embodiments of the present invention find application with other examples in which the eNodeB layer and the relay node layer can make transmissions of necessarily exactly the same information and not at exactly the same time on exactly the same frequency and time resources. For example, the donor eNodeB would provide the data which is to be broadcast using a uni-cast bearer, and only when both the donor eNodeB and the relay node layers have the information does the simultaneous transmission begin.

In other examples the relay node layer and the donor eNodeB layer are arranged to transmit MBMS signals on the same time and frequency channels. However although the MBMSFN OFDM symbol boundaries are time aligned, the content transmitted by each layer maybe different, for example the relay node may transmit a time delayed version of the content of the donor eNodeB layer which is transmitted earlier. The symbol level time alignment can therefore assist the mobile communications device to more easily ‘unravel/exploit’ the inter symbol interference. Furthermore the symbol level time alignment can be made to reduce interference between transmissions made on the relay node layer and on the eNodeB layer. This is because a reason for using different time and frequency resources might be to orthogonalise/manage interference, which may for example make implementation easier.

Various further aspects and features of the present invention are defined in the appended claims.

### BRIEF DESCRIPTION OF THE DRAWINGS

Example embodiments of the present invention will now be described with reference to the accompanying drawings where like parts are provided with the same designations and in which:

FIG. 1 is a schematic block diagram of a mobile radio network operating to support a multimedia broadcast multicast communications service;

FIG. 2 is a schematic block diagram of the mobile radio network shown in FIG. 1 adapted to include a relay node;

FIG. 3 is a schematic block diagram illustrating an arrangement in which one example of a donor base station (eNodeB) and a relay node are disposed in order to support a single frequency MBMS network;

FIG. 4a is graph of frequency with respect to time representing transmission from a base station of a first uni-cast signal from the base station to the relay node and a subsequent multi-cast transmission of signals representing broadcast data; and FIG. 4b is graph of frequency with respect to time representing transmission from a relay node of a multi-cast transmission of signals representing broadcast data contemporaneously with the base station;

FIG. 5 is a schematic block diagram illustrating an example of a donor base station, a relay node and a mobile communication device adapted according to the present technique;

FIG. 6a is a schematic illustration of an OFDM transmitter and FIG. 6b is a schematic illustration of an OFDM receiver;

FIG. 7a is a schematic illustration of signals transmitted by a base station and a mobile communications device illustrating the effects of not using timing advance reproduced from [sesia]; and FIG. 7b is a schematic illustration of signals transmitted by a base station and a mobile communications device illustrating an effect of using timing advance information; and

FIG. 8a is a schematic illustration of signals transmitted by a base station and a relay node without using timing advance; and FIG. 8b is a schematic illustration of signals transmitted by a base station and a relay node in accordance with the present technique.

### DESCRIPTION OF EXAMPLE EMBODIMENTS

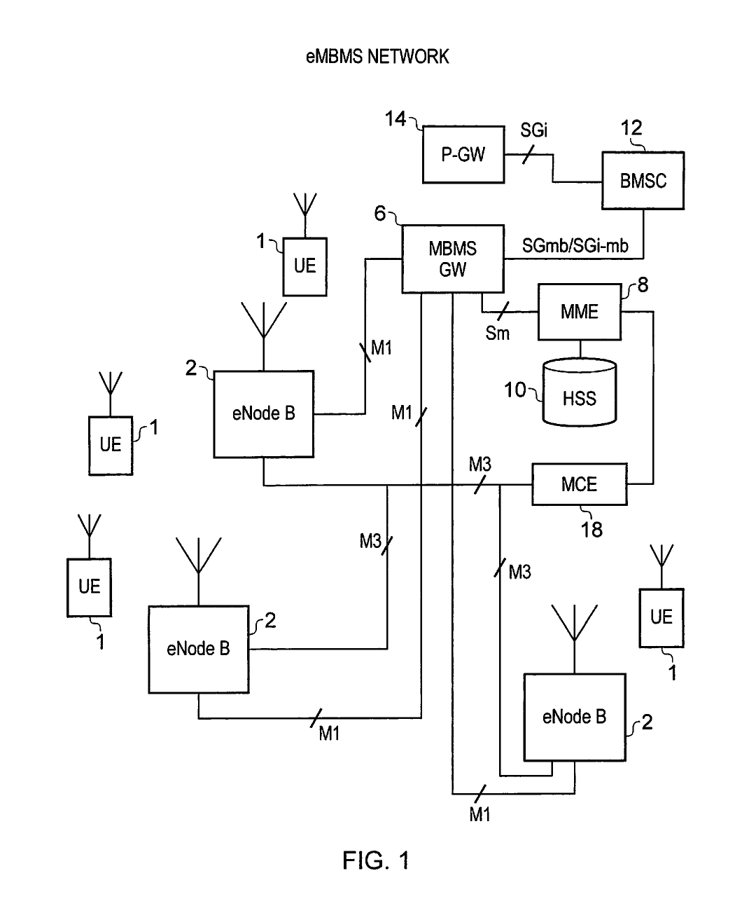

Embodiments of the present invention will now be described with reference to an implementation which uses a mobile radio network operating in accordance with the 3GPP Long Term Evolution (LTE) standard. In the following description an example application for embodiments of the present technique will be described with respect to enhanced Multimedia Broadcast Multicast Services (eMBMS) such as that which is currently being proposed for the LTE project within 3GPP. FIG. 1 provides an example architecture of an LTE network, which has been adapted to form a network for supporting a Multimedia Broadcast Multicast Service (MBMS). As shown in FIG. 1 and as with a conventional mobile radio network, mobile communications devices designated as a mobile communications device (UE) 1 are arranged to communicate data to and from base stations 2 which are referred to in LTE as enhanced NodeBs (eNodeB).

The base stations or eNodeB's 2 are connected to a MBMS GW 6 which is arranged to perform routing and management of the MBMS services to the mobile communications devices 1 as they roam throughout the mobile radio network. In order to maintain mobility management and connectivity, a mobility management entity (MME) 8 manages the enhanced packet service (EPS) connections with the communications devices 1 using subscriber information stored in a home subscriber server (HSS) 10. Other core network components include a Broadcast Mobile Switching Centre (BMSC) 12, a packet data gateway (P-GW). More information may be gathered for the LTE architecture from the book entitled “LTE for UMTS OFDM and SC-FDMA based radio access”, Holma H. and Toskala A. page 25 ff, and the MBMS which is explained in 3GPP TS 36.300 V9.4.0 (2010 June).

Also forming part of the network shown in FIG. 1 is a multicell/multicast coordination entity MCE 22 which is a logical entity which may be part of another entity within the eMBMS logical architecture. The MCE performs functions such as a admission control and the allocation of radio resources used by all of the eNodeB's in an MBMS single frequency network for multicell MBMS transmissions using MBSFN operations. Besides the allocation of time/frequency radio resources the MCE also decides other radio configuration functions. The MBMS gateway 6 on the other hand is arranged to send broadcast data packets for the MBMS to each of the eNodeB's transmitting the service. The MBMS gateway 6 uses IP multicast as a means for forwarding MBMS user data to the eNodeB's

### Relay Nodes

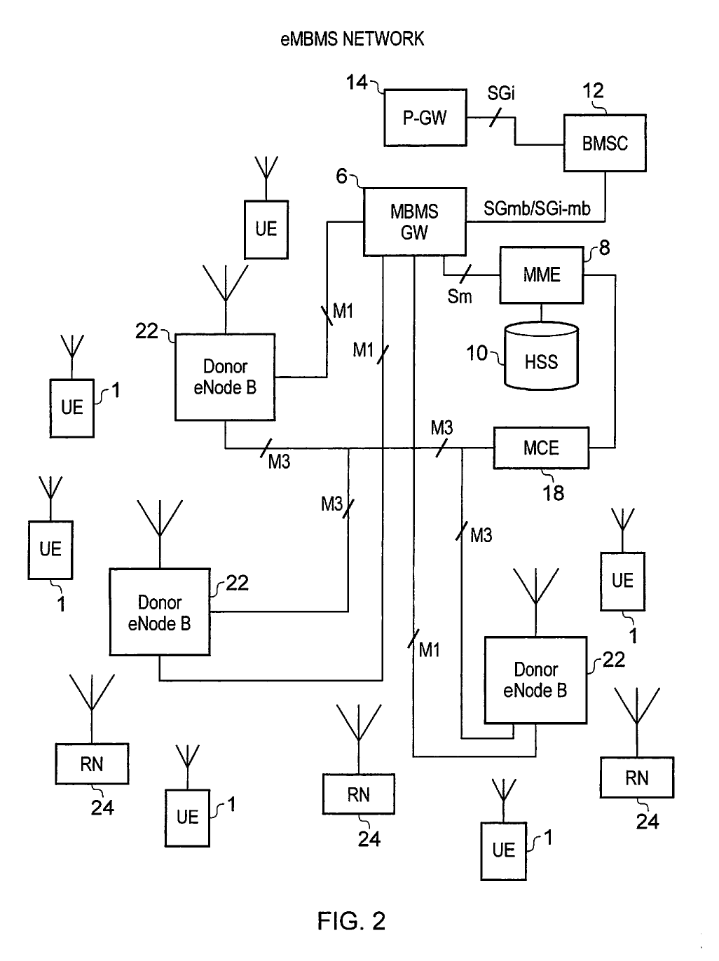

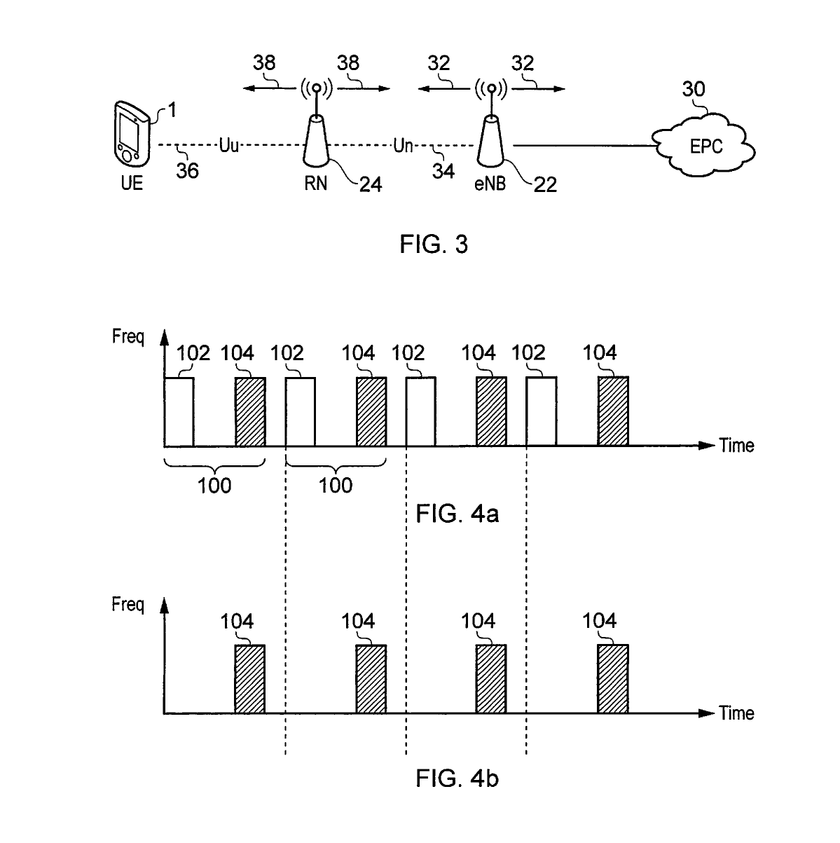

The mobile radio network shown in FIG. 1 is shown in FIG. 2 but adapted to include relay nodes for extending the range of the eNodeB's 22. Furthermore, in accordance with the present technique some adaptation of the eNodeB 22 is required in order to support the relay node deployment. The relay nodes 24 therefore form what can be termed as a relay node layer for transmission whereas the eNodeB 22 also form a layer of transmission for communicating the MBMS data packets to the mobile communications devices 1. Thus, the layer of relay nodes is deployed in order to extend the range of communication which can be achieved with the eNodeB's alone and finds application with a transmission of broadcast data to support and eMBMS although not exclusively because other services can be supported. The operation of the relay node shown in FIG. 2 can be explained more easily with reference to a simplified representation shown in FIG. 3.

In FIG. 3 data packets such as those produced by a source of MBMS data are fed from an enhanced packet communication system EPS 30 to an eNodeB 22. The data packets are then received by the eNodeB 22 and transmitted on a pre-determined channel which broadcasts the MBMS data packets to one or more mobile communications devices within a range provided by the eNodeB which have subscribed to receive the MBMS data packets. Thus, the eNodeB is transmitting on a pre-designated channel the MBMS broadcast data as represented by arrow 32.

In order to extend a range of communication which can be achieved by the eNodeB 22 alone, a relay node 24 is disposed within a cell of the mobile radio network served by the eNodeB. In one example, the relay node 24 is arranged to receive the data from the MBMS channel communicated by the eNodeB 22 as if the relay node 24 was itself was a mobile communications device. In another example the relay node may receive the MBMS data from the donor eNodeB as the donor eNodeB is broadcasting to mobile communications devices on a broadcast channel before re-transmitting the received data. The relay node 24 then re-transmits the data in accordance with an MBMS communication so that the broadcast data can be received by one or more communications devices 1 which have subscribed to the MBMS service.

Embodiments of the present invention have therefore been devised in order to make improvements to the support of relay nodes in a mobile communications networks and in one example where the mobile communications network is supporting the communication of MBMS services.

In one known arrangement disclosed by CMCC (R2-103960), the relay node 24 is arranged to receive data from the unicast link 34 from the eNodeB 22. At this time however, the eNodeB is not broadcasting the MBMS broadcast data on the MBMS channel but simply communicating the data or a portion of that data in readiness for broadcast. At a pre-designated time perhaps at a later time slot within an OFDM frame, both the eNodeB 22 and the relay node 24 transmit the MBMS data for reception by one or more mobile communications devices 1 within the mobile radio network. As such the re-transmission by both the relay node 24 and the eNodeB 22 can be arranged on the same frequency and same time slot thereby forming a single frequency network deployment as if the relay node 24 where itself an eNodeB. However, the present invention is not limited in application to the transmission of the same content at the same time on the same frequency from the donor eNodeB and the relay node, after the data has been received by the relay node from the donor eNodeB from a uni-cast channel. In other examples, the data transmitted by the relay node and the eNodeB may by time aligned, but the content may be different, such as in an example in which the relay node is receiving and then retransmitting the data received from the donor eNodeB one TTI earlier to the time the data is being transmitted. In this example, there remains a requirement to ensure that the transmissions from the relay node and the eNodeB are time aligned so that they can be received contemporaneously at the receiver.

FIG. 4 provides an illustration of the transmission of the MBMS data from the relay node and the donor eNode B 22 as explained above with reference to FIG. 3. In FIG. 4 a first plot of signal transmissions with respect to time is provided for the donor eNode B in FIG. 4a. FIG. 4b illustrates the transmissions from the relay node 24. As shown in FIG. 4a the transmission of the data from the donor eNode B is divided into sub-frames 100. The sub-frames are correspondingly reproduced by the relay node 24. As shown in FIG. 4a, for example each of the sub-frames includes a transmission as a unicast transmission from the donor eNode B shown by a clear block 102. Each of the unicast data transmissions 102 are then received by the relay node 24. At some time after the unicast transmission 102 both the relay node and the donor eNode B 22, 24 transmit the data received from the unicast transmission 102 as a broadcast transmission shown by a hatched block 104.

### Adapted Relay Node

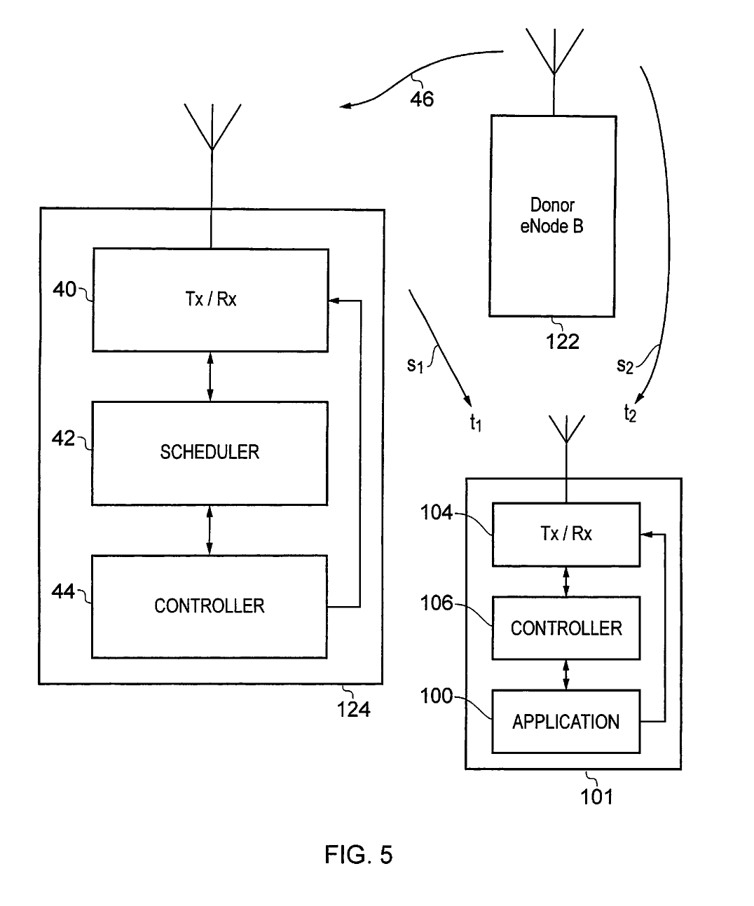

A relay node adapted in accordance with the present invention is illustrated in FIG. 5. As shown in FIG. 5 a relay node 124 includes a transmitter and receiver unit 40 a scheduler 42 and a controller 44. The controller 44 is adapted to arrange for reception and transmission of data which is to be broadcast by the relay node having been received by the relay node. Thus the transmission and reception of data by the relay node 124 is effected using a scheduler which schedules transmission on time slots of sub-frames of the wireless interface of LTE and receives data via the LTE wireless access interface using the transceiver unit 40. The controller 44 is arranged to control the transceiver unit 40 and the scheduler 42 to perform operations required to receive the MBMS data and to transmit the MBMS data in accordance with the present technique.

As shown in FIG. 5 according to the arrangement shown in FIG. 4, in which the relay node 124 and the donor eNodeB 122 are arranged to transmit the broadcast data of an MBMS service substantially in the same time slot. A mobile communications device 101 may be configured to receive a first signal representing the broadcast data s1 transmitted by the donor eNodeB 122 at time t1 and a second signal s2 representing the broadcast data transmitted by the relay node 124 at time t2 and to combine the data received from the first and second signals s1, s2 . . . The mobile communications device 101 includes a transceiver unit 104 a scheduler 106 and a controller 108. The transceiver unit 104, the scheduler 106 and the controller 108 performs similar functions to the transceiver unit 40, the scheduler 42 and the controller 44 which are performed by the relay node.

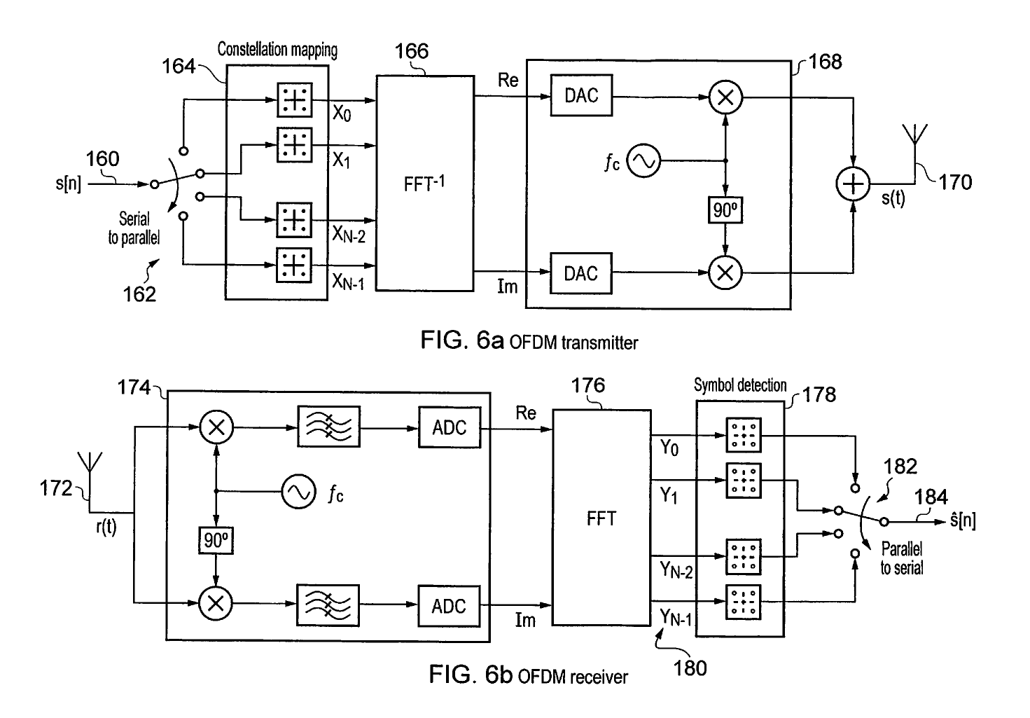

The transceiver unit 40 in the relay node 124 as well as a corresponding transceiver unit in the donor eNodeB 122 (not shown) and the transceiver unit 40 in the relay node 124, in one example each include a transmitter and a receiver which operate in accordance with an LTE standard which utilises orthogonal frequency division multiplexing OFDM to communicate data. An example illustration of a transmitter and a receiver is provided in FIGS. 6a and 6b.

FIG. 6a provides an illustrative representation of a block diagram of a simplified representation of an OFDM transmitter. In FIG. 6a data to be transmitted is received on an input terminal 160 and mapped onto a plurality of constellation points for each of a plurality of narrow band transmission channels by a serial to a parallel converter 162 and a constellation mapper 164. An inverse Fast Fourier Transform (FFT) 166 then converts the set of narrow band carriers into the time domain which is then up converted and modulated for RF transmission by an RF front end 68 and transmitted from an aerial 170.

On the receiver side FIG. 6b includes a receive antenna 172 and an RF front end and down converter 174 for transforming the received OFDM symbol to a base band form. The real and imaginary components of the OFDM symbol which are converted by the RF front end 174 into the discrete time domain is then transformed from the time domain into the frequency domain by an FFT 176. A symbol detector 178 then converts the frequency domain data providing a symbol on each of the narrow band carriers at an output of the FFT 180 and forms for each of the symbols provided on the narrow band carriers an estimate of the data which is fed to a parallel to serial converter 182 and then output on an output channel 84 which provides an estimate of the originally transmitted data. The symbols decoder/detector 178 also typically includes an equaliser, which equalises the received base band frequency domain signal from the FFT 76 before the data symbols are recovered from the sub-carriers of the OFMD symbol.

Although signals which have travelled from different paths to reach the receive antenna, they may also have been transmitted from different sources, such as from the relay node and a donor eNodeB. It is a property of the FFT as present in the transmitter 166 and the receiver 176 which allows signals to be equalised in the frequency domain so that the energy from different sources can contribute to the communication of the data symbols carried by the OFDM symbols. Thus, as far as a receiver of an OFDM signal is concerned the signal transmitted from a separate transmitter will appear as a separate transmission path as if the same signal has been transmitted on a different transmission path. Therefore provided a difference between the transmission paths is less than a cyclic prefix of repeated data samples of the OFDM symbol and the FFT is synchronised to capture as much of the energy of the received signal as possible from the different transmission paths then the FFT can recover data from a combination of the transmission parts.

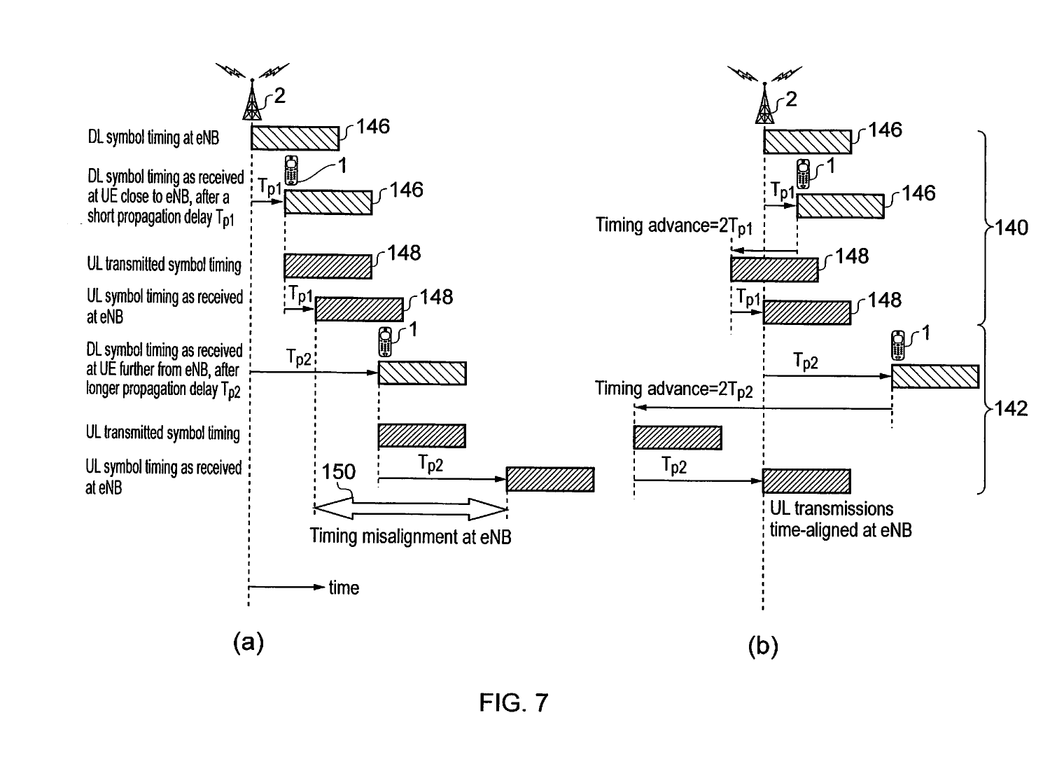

As will be appreciated from the above description, in order to form a single frequency network in one implementation the relay nodes should re-transmit the MBMS data as far as possible in synchronism with the transmission of the MBMS data form the donor eNode B so that a receiving mobile communications device 1 can combine the signals received from the donor eNode B and the relay node 122, 124. As such, as shown in FIG. 5, a receiver in the transceiver unit 104 can combine the first signal s1 transmitted by the donor eNode B 122 and the second signal s2 transmitted by the relay node 124 representing the same broadcast data with an improved likelihood of correctly recovering the broadcast data. However in order to form a single frequency network the receiver in the mobile communication device 101 should receive the first signal s1 from the donor eNode B 122 and the second signal s2 from the relay node 124 within a guard period of the cyclic prefix of the OFDM symbols. Therefore, as far as possible, the first transmission of the first and second signals s1, s2, should be synchronised. To this end, the present technique arranges for the relay node 124 to utilise timing advance information which is provided by the donor eNode B 122 as a part of a conventional operation of a wireless access interface operating in accordance with the LTE standard. Timing advance is explained in the following paragraphs with reference to FIG. 7 for completeness although it would be appreciated that FIG. 7 provides an explanation of a known technique.

### Timing Advance

FIG. 7 provides two example timing diagrams for transmitted signals in FIG. 7a without timing advance and in FIG. 7b with timing advance. Furthermore, FIGS. 7a and 7b provide a first example 142 in which a mobile communication device 1 is relatively close to the eNode B providing a short propagation delay TP1 and a second example 142 in which the mobile communication device 1 is at a point which is far from the eNode B 122 and so that the propagation delay TP2 is longer. As shown in FIGS. 7a and 7b the eNode B transmits a symbol within a predetermined time slot 146. The timing of the transmission of the symbol 146 is with respect to the eNode B′s own clock and with respect to that clock a transmission time frame is determined for the uplink and the downlink.

As a result of a propagation delay TP1, the symbol 146 is received at the mobile communications device 1 after a delay of TP1. As a result, if the mobile communications equipment was arranged to take timing of receipt of that symbol as an indication of the transmission time frame then when making an uplink transmission 148 with respect to that timing, the uplink symbol 148 will be received at the eNode B after a further propagation delay TP1. As such, the symbol transmitted by the mobile communications device on the uplink will be received after a total propagation delay of TP1×2 which may fall outside a time slot in which the up-link symbol 148 is to be transmitted. Accordingly, as shown in FIG. 7b timing advance of 2TP1 is used to advance the transmission of the uplink symbol 148 resulting in the receipt of the up-link symbol 148 within a time slot which has been allocated to that uplink symbol when received at the eNode B2.

The second example shown in section 142, provides a corresponding example but for a larger timing advance TP2. Accordingly, in order to avoid a misalignment of receipt of the up-link symbol at the eNode B represented as a double headed arrow 150 timing advance is used to bring forward the time of transmission of the uplink symbol so that this arrives at the eNode B substantially within a time slot allocated for the transmission.

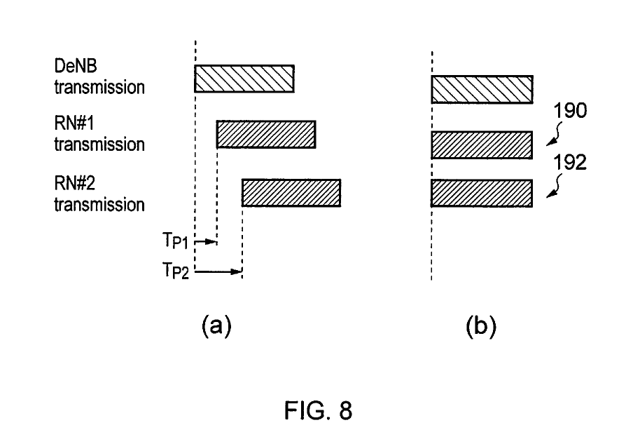

FIG. 7 taken from [Sesia] provides an example illustration of timing advance which is reused by the relay node 124. In accordance with the conventional operation the donor eNode B 122 communicates a timing advance information on the down-link when transmitting the first unicast signal 102 as shown in FIG. 4a. The timing advanced information is then used by the relay node 124 to advance the time when the second signal s2 104 is transmitted by the relay node. Such an arrangement is illustrated for two relay nodes 190, 192 in FIGS. 8a and 8b. FIG. 8a shows an example where timing advance is not used whereas FIG. 8b shows an example where timing advance is used.

The LTE uplink timing advance procedure is described in [Sesia et al]. The initial timing advance is set using a timing advance procedure, which involves the mobile communications device transmitting a random access preamble from which the eNodeB can make an estimate of the uplink timing and respond with an 11 bit initial timing advance command contained within the Random Access response (RAR) message. Timing advance can be specified between 0 and 670 micro-secs with resolution of 0.52 microsecs.

Once the timing advance has been set for each mobile communications device it is necessary to keep it updated, this can be done in a broadly similar way to that just described however, measurements may be made on any other uplink signal, such as those used for carrying SRS, CQI, and ACK/NACK. The timing advance update commands are generated by the MAC layer and maybe multiplexed with other downlink transmissions made on the PDSCH.

There is a trade off between maintaining accurate timing advance and the signalling overhead involved in maintaining the timing update accuracy. Hence the mobile communications device sets a timer after each uplink timing advance has been received and is prohibited from sending uplink messages if the timer has expired. Where the timer has expired the mobile communications device would need to re-establish the timing advance using the RACH preamble based approach.

### Use of Uplink Timing Advance Information for Synchronising Downlink MBMS Transmissions

As illustrated in FIGS. 8a and 8b embodiments of the present invention provide a relay node 124 which is arranged to use an uplink timing advance value to determine the timing advance which should be applied for downlink MBMS transmissions.

FIG. 8a shows that the propagation delay between each relay node and its associated donor eNodeB may be different. Hence if each relay node were to simply synchronise/align its LTE frame timing according to the signal received from the donor eNodeB, then transmissions form the relay nodes would not be symbol level synchronised and hence transmissions from multiple relay nodes could not be guaranteed to arrive at the UE within the cyclic prefix window of the mobile communications devices (given also that there will also be accumulative propagation delay differences on each of the Uu interfaces).

FIG. 8b illustrates the symbol level synchronisation in relay node transmissions that occurs once the timing advance is applied to the relay node MBMS transmissions. Specifically the timing advance which is signalled to the relay node for the purposes of uplink (relay node to donor eNodeB) transmission is divided by 2 in order to determine the symbol level synchronisation/timing advance which should be applied for downlink MBMS transmission.

Embodiments of the present invention can therefore provide an arrangement for achieving, as far as possible, synchronisation in the transmission from one or more relay nodes within a mobile radio network, so that transmissions from macro-diverse relay nodes can arrive at mobile communications devices substantially at the same time. For communication of broadcast data for an MBMS, using LTE and OFDM, synchronising the transmission of signal representing the broadcast data can reduce OFDM symbol dispersion so that, as far as possible this does not extend beyond a cyclic prefix. To this end for example MBSFN networks are arranged to transmit signals representing the broadcast data from donor base stations and relay nodes substantially at the same time to ensure that any macro-diverse MBMS transmissions arrive at communications devices with time offsets that fall within the cyclic prefix of the OFDM symbol, thereby allowing equalisation of the combined received signal.

In a network which includes both base stations and relay nodes, it may be desirable to either:
Transmit an MBMS signal which carries the same information from both relay nodes and base stations at the same time, or
Ensure that all transmissions from base stations occur at the same time, t1 and all transmissions from relay nodes occur at the same (but later) time, t2 so that the OFDM symbol boundaries are aligned. In this scenario where relay node layer and eNodeB layer use the same time/frequency resources the macro-diverse transmissions from all base stations simply appear as different multipath components in the received symbol (that corresponded to transmission time, t1) and likewise the macro-diverse transmissions from all relay nodes simply appear as different multipath components in the received symbol (that corresponded to transmission time, t2). Various possible methods exist for combining the signals received from the base station layer' and from the ‘Relay node layer’.

A propagation delay between the base station and the relay node, which is a delay over the Un interface, needs to be accommodated in order to ensure the synchronised transmission from all relay nodes, so as to ensure that any dispersion at the receiver in the mobile communications device falls within the cyclic prefix.

Hence embodiments of the present technique can provide a method for determining a propagation delay of signals over the Un interface between the donor eNodeB 122 and the relay node 124 and using the propagation delay to ensure synchronised MBMS transmissions from relay nodes. It is assumed that existing mechanisms, eg GPS, will be used to ensure synchronised transmission from the donor eNodeBs.

If there is uplink information available then this could be useful, but it is not essential. Mobile devices communicate over the Uu interface to the relay node and then the relay node backhauls the information on the Un 34 shown in FIG. 3 to perform the timing advance procedure explained above with reference to FIGS. 7 and 8. According to the present technique the timing advance information provided to the relay node 124 from the Un interface 34 is used by the controller 44 in the relay node 124 to advance the time of its transmissions towards the Donor eNodeB 124 so that uplink Un frames arrive within the cyclic prefix window at the Donor eNodeB 124. This timing advance information is additionally utilised to provide a synchronisation mechanism for the MBMS transmissions from the relay node layer by appropriately retarding or advancing the timing of the MBMS transmissions.

### Additional Embodiments

There may also be mobile communications devices within the coverage area of the relay node which are receiving PDSCH transmissions. The PDSCH transmissions will be made in different sub-frames to the MBMS transmission. This may impose requirements on when or how frequently timing advances could be made. Some of the embodiments below are written with this issue in mind:
1. In one embodiment the relay node and eNode B are assumed to be stationary. The timing advance is computed once when the relay node is booted up and the same timing advance is applied throughout the period that the relay node is active.
2. In another embodiment, and to prevent loss of UE synchronisation (for UE's under the coverage of the RN) timing advances in the downlink transmission are only allowed to occur at times when no information is being transmitted from the relay node, for a given period. For example this might be the case in the middle of the night.
3. In another embodiment the relay node scheduler, on detecting the need for a synchronisation update, may create a gap in the transmission of downlink traffic (MBMS and PDSCH) in order to implement the timing advance, and possibly also to give time for UE receivers to re-synchronise to the new timing before the eNodeB re-commences downlink transmissions.
4. The method can easily be extended to a daisy chain of >1 relay node attached to a given enodeB.
5. If the relay node has a need to transmit MBMS data but has no need to send data in the uplink, then it could be configured to maintain the uplink timing advance information, even though there is no data to be sent on the uplink (ie it could be configured to maintain ‘uplink’ synchronisation purely for the purposes of maintaining downlink synch in the MBMS transmissions).
6. If a relay node were to be deployed purely for the purposes of MBMS transmission then the existing LTE mechanisms for determining DeNB-RN propagation delay could still be applied, even though there is no data to transmit in the uplink

Various further aspects and features of the present invention are defined in the appended claims.

### REFERENCES

[Sesia] ‘LTE—the UMTS long term evolution—From theory to practice’, Sesia, Toufik, Baker
CMCC (R2-103960)

1. A mobile radio communications network for communicating broadcast data to a plurality of mobile communications devices by transmitting and receiving the broadcast data via a wireless access interface, the mobile radio communications network including
at least one base station for transmitting signals to and receiving signals from mobile communications devices attached to the base station, and
a relay node arranged in operation to receive a first signal representing the broadcast data transmitted by base station to the relay node via a first down-link channel of the wireless access network, and to retransmit the broadcast data as a second signal for reception by one or more mobile communications devices via a second channel of the wireless access network, wherein the first channel between the relay node and the base station includes an up-link channel for transmitting signals from the relay node to the base station and a down-link channel for transmitting signals from the base station to the relay node and the base station is arranged to communicate timing information to the relay node and the relay node is adapted to adjust the timing of the transmission of the second signal via the second channel using the timing information provided by the base station.

2. A mobile radio communications network as claimed in claim 1, wherein the timing information provided by the base station includes a total round trip delay between the relay node and the base station and the relay node is arranged in operation to adapt the transmission of the second signal in accordance with a half of the value of the round trip delay.

3. A mobile radio communications network as claimed in claim 1, wherein the base station is adapted to transmit a third signal representing the broadcast data for reception by one or more of the mobile communications devices on the second channel contemporaneously with the transmission by the relay node.

4. A relay node for use in a mobile radio communications network for communicating broadcast data to one or more mobile communications devices, the mobile radio communications network including at least one base station for transmitting signals to and receiving signals from mobile communications devices attached to the base stations, the relay node being arranged in operation
to receive a first signal representing the broadcast data transmitted by the base station to the relay node via a first down-link channel of the wireless access network, and
to retransmit the broadcast data as a second signal for reception by one or more mobile communications devices via a second channel of the wireless access network, wherein the first channel between the relay node and the base station includes an uplink channel for transmitting signals from the relay node to the base station and a down-link channel for transmitting signals from the base station to the relay node and the base station is arranged to communicate timing information, and the relay node is adapted to adjust the timing of the transmission of the second signal via the second channel using the timing information provided by the base station.

5. A relay node as claimed in claim 4, wherein the timing information provided by the base station includes a total round trip delay between the relay node and the base station and the relay node is arranged in operation to adapt the transmission of the second signal in accordance with a half of the value of the round trip delay.

6. A method of communicating broadcast data to a plurality of mobile communications devices by transmitting and receiving the broadcast data via a wireless access interface, the method comprising
providing at least one base station arranged in operation to transmit signals to and receive signals from mobile communications devices attached to the base station, and
providing a relay node,
receiving at the relay node a first signal representing the broadcast data transmitted by the base station to the relay node via a first down-link channel of the wireless access network, and
retransmitting the broadcast data from the relay node as a second signal for reception by one or more mobile communications devices via a second channel of the wireless access network, wherein the first channel between the relay node and the base station includes an up-link channel for transmitting signals from the relay node to the base station and a down-link channel for transmitting signals from the base station to the relay node and the base station is arranged to communicate timing advance information for use by the relay node in transmitting signals in the up-link channel to the base station, and the re-transmitting by the relay node includes adjusting the timing of the transmission of the second signal via the second channel using the timing information provided by the base station.

7. A method as claimed in claim 6, wherein the timing information provided by the base station includes a total round trip delay between the relay node and the base station and the method includes adapting the transmission of the second signal in accordance with a half of the value of the round trip delay.

8. A method as claimed in claim 6, wherein the base station is adapted to transmit a third signal representing the broadcast data for reception by one or more of the mobile communications devices on the second channel contemporaneously with the transmission by the relay node.

9. A method as claimed in claim 7, wherein the base station is adapted to transmit a third signal representing the broadcast data for reception by one or more of the mobile communications devices on the second channel contemporaneously with the transmission by the relay node.

10. A mobile radio communications network as claimed in claim 2, wherein the base station is adapted to transmit a third signal representing the broadcast data for reception by one or more of the mobile communications devices on the second channel contemporaneously with the transmission by the relay node.
